(19) United States
(12) Patent Application Publication
(10) Pub. No.: US 2021/0396136 A1
(43) Pub. Date: Dec. 23, 2021

(54) SCALING BAR

(71) Applicant: Steven M. Elliott, Elko, NV (US)

(72) Inventor: Steven M. Elliott, Elko, NV (US)

(21) Appl. No.: 17/350,332

(22) Filed: Jun. 17, 2021

Related U.S. Application Data
(60) Provisional application No. 63/040,287, filed on Jun. 17, 2020.

(51) Int. Cl. E21C 37/22; B25G 1/04

(52) U.S. Cl. CPC E21C 37/22; B25G 1/04

(57) ABSTRACT

An adjustable scaling bar may feature a two-piece handle design with two coaxial tubes which may be variably lengthened and secured. A neck portion of the handle supports a scaling chisel while the outer handle portion supports the neck portion. The scaling bar may be collapsed to a smaller length when needed for transport but may also be extended to a longer length for use. A collar may be added to support other tools.

### CROSS-REFERENCES TO RELATED APPLICATIONS

This Application claims priority as a non-provisional perfection of prior filed U.S. Application 63/040,287, filed Jun. 17, 2020, and incorporates the same by reference herein in its entirety.

### FIELD OF THE INVENTION

The present invention relates to the field of mining and more particularly relates to an adjustable-for-length scaling bar for clearing jutting and loose rocks on the ceiling of a mine shaft.

### BACKGROUND OF THE INVENTION

Mining is an ancient industry having been practiced for many millennia by many different cultures. Currently mining is accomplished in two distinct forms. The first is surface mining, where minerals and ores are extracted by simply stripping all surface layers of soil, rock, and vegetation are removed from over the deposit. The second is an underground, or subsurface, mine. Subsurface mines require a shaft be dug into the earth in order to reach the desired mineral deposits. These shafts can be particularly dangerous if not dug and supported properly. It should come as no surprise, the, that there are many safety regulations regarding mine safety. Some of these regulations involve the clearance of loose or otherwise dangerous material from the ceiling and walls of these shafts. The removal of this material is called scaling and usually involves an individual taking a long steel bar and poking and scraping the loose material off the roof of the shaft. These steel bars are known as scaling bars incoming lights of anywhere between 6 and 12 feet and are tipped with at least one hardened steel spike or hook. Unfortunately, the length of these scaling bars makes them difficult to carry from place to place, and larger scaling bars cannot be effectively carried on vehicles (particularly the smaller ones used in shaft mines). Until now, an effective, adjustable scaling bar has not been brought to market.

The present invention is a scaling bar with a preferred adjustable length from 6 to 10 feet and allows for a scaling bar to be easily carried and deployed inside a mine shaft, even on a smaller vehicle, where 6 feet is a more customary and convenient length for transport of the scaling bar, both by the manufacturer and shipper as well as the end user. Larger or smaller bars are possible by utilizing different length components.

### SUMMARY OF THE INVENTION

In view of the foregoing disadvantages inherent in the known types of scaling bars, an improved adjustable scaling bar may provide a bar embedded in a tubular handle with a secure lock to hold the bar and tube in relative position to each other in order to accomplish these objectives.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also, it is to be understood that the phraseology and terminology employed herein are for description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is an elevation depicting use of an exemplary scaling bar according to the teachings of this invention.

FIG. 2 is a perspective view of the scaling bar of FIG. 1, compacted.

FIG. 3 is a perspective view of the scaling bar of FIG. 1, extended.

FIG. 4 is a sectional view of the scaling bar of FIG. 2.

FIG. 5 is a sectional view of the scaling bar of FIG. 3.

FIG. 6 is a partial perspective view of the scaling bar of FIG. 1, detailing the handle, throat, and iron of the scaling bar.

FIG. 7 a partial perspective view of an alternate scaling bar, detailing the handle, throat, and iron of said alternate scaling bar.

FIG. 8 is a perspective view of an alternate embodiment of the scaling bar.

FIG. 9 is a perspective view of the scaling bar of FIG. 8 with a mounted rock bolt plate.

### DETAILED DESCRIPTION OF THE PREFERRED EMBODIMENT

With reference now to the drawings, a preferred embodiment of the scaling bar is herein described. It should be noted that the articles “a”, “an”, and “the”, as used in this specification, include plural referents unless the content clearly dictates otherwise.

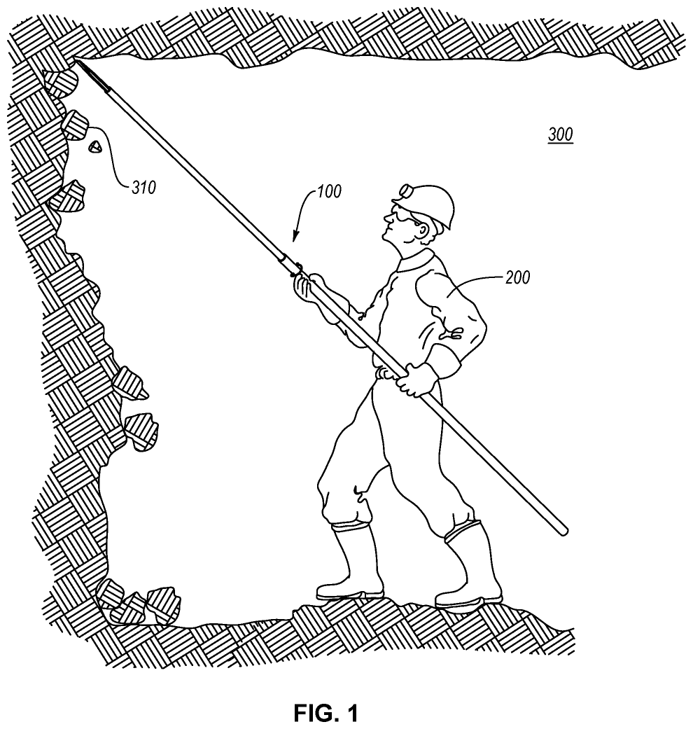

With reference to FIG. 1, a scaling bar 100 is a tool used by an individual 200 to remove loose, overhanging, or otherwise dangerous debris 310 from a dug shaft 300, such as in a mine. Appropriate scaling makes the shaft 300 safer by removing the debris 310 from areas where individuals may be hurt.

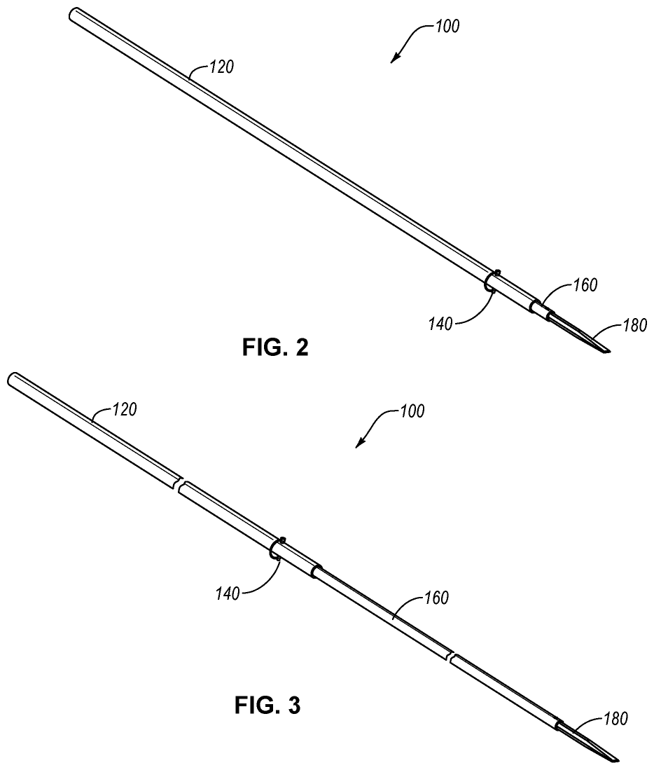

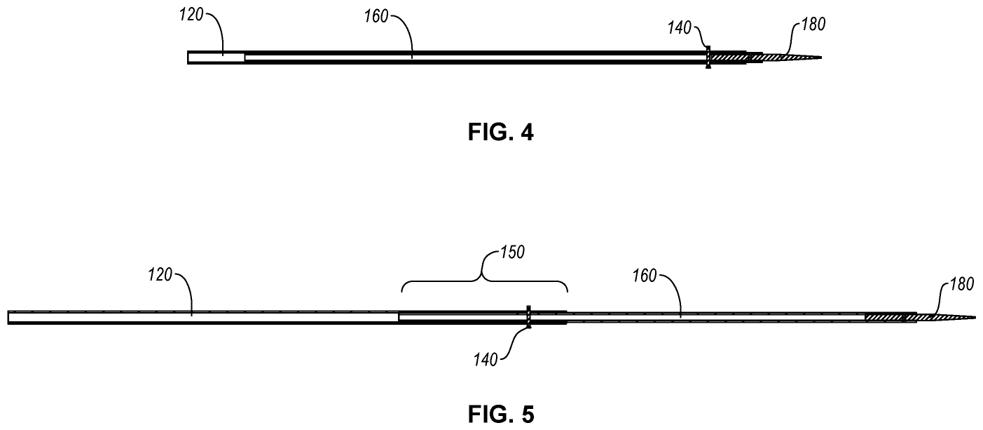

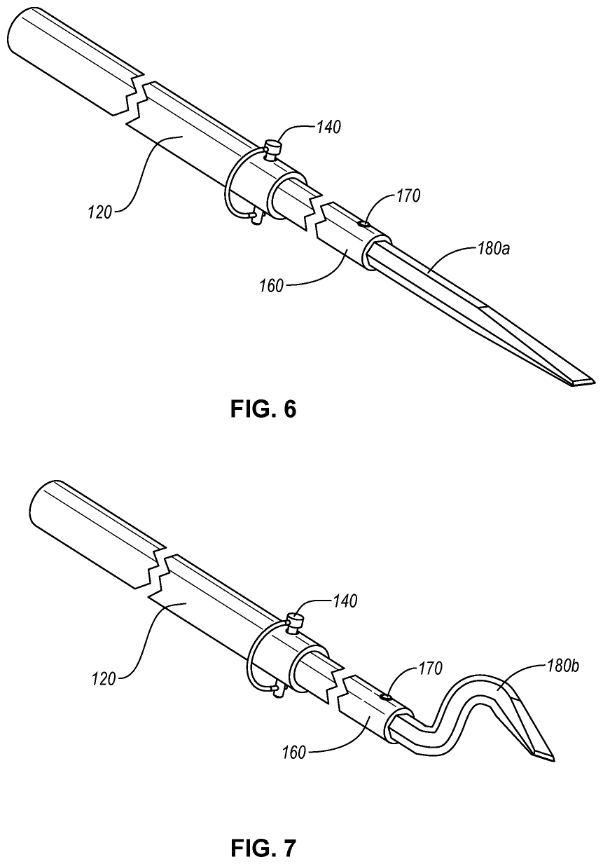

As seen in FIGS. 2-5, the scaling bar has four main components: an outer handle 120, a neck 160 coaxial with the outer handle 120, a latch mechanism 140, and a scaling head, or chisel, 180. Outer handle 120 is essentially a tube with an inner diameter corresponding to the outer diameter of the neck 160. The neck 160 is ideally also a tube, but it has an inner diameter that matches the outer diameter of a chisel 180. As may be seen in FIG. 6, the latch mechanism 140 may be used to selectively engage and disengage the outer handle 120 and neck 160. A simple shaft locking pin may suffice for this purpose. Also as seen in FIG. 6, Chisel 180 may be secured in the neck 160 by any means sufficient to hold it in place during use. An easy method could be the use of a dowel pin 170, which may or may not be removable. Another method could be the use of a threading interface. Different chisel styles 180a, 180b (FIGS. 6 Et 7) may be utilized by the scaling bar 100 if the chisel is removable.

The outer handle 120 and neck 160 may be manufactured from any metal, with a preference towards aluminum. As scaling chisels 180 in the market today are typically found in varying widths, the neck 160 need only comport with a desired standard size. As an example, a 0.945″ scaling chisel would fit in a neck 160 with a 0.957″ inner diameter (1 inch, schedule 80 pipe). Such a neck 160 could conceivably have a tube thickness of 0.179″ and an outer diameter of 1.315″. The outer handle could then be a schedule 40 aluminum pipe with a 1.38″ diameter. If both neck 160 and outer handle 120 are 6 feet long, there should be about 2 feet of overlap 150 (FIG. 5) at full extension to provide adequate support to the neck 160 during use. Latch mechanism should be located about 6 inches from the end of the outer handle 120 for similar reasons. Various stops in the form of holes which correspond to a desired length may be machined in the neck 160 to allow for variable length, i.e., by the foot for length options of 6, 7, 8, 9, and 10 feet. The neck 160 may be a solid cylinder with a socket for receiving the chisel 180, but this can add significant weight to the front of the scaling bar and is not preferred. Different lengths may be manufactured, but in each case some degree of overlap between the neck 160 and outer handle 120 will be required. For longer bars, at least 2 feet of overlap would be required, and possibly more. Shorter bars could conceivably have less overlap.

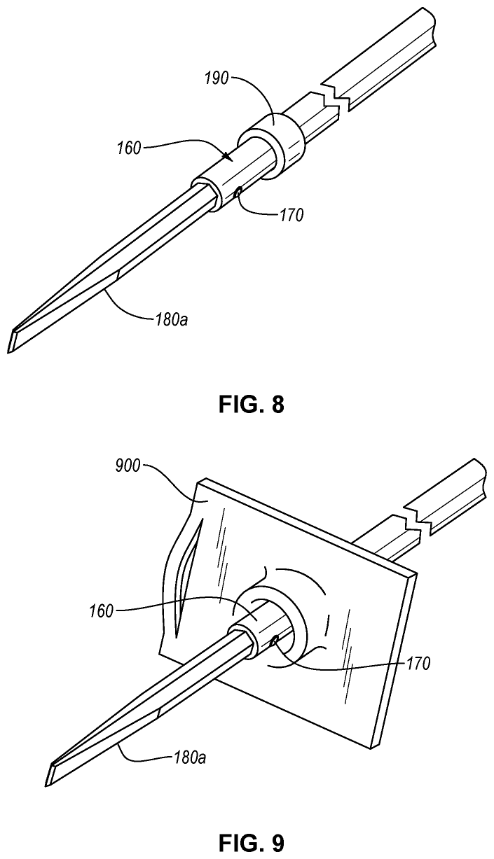

An alternate embodiment of the scaling bar is shown in FIGS. 8 and 9 where a collar 190 is added to the neck 160, circumscribing it proximate scaling chisel 180a. The collar 190 supports a rock bolt plate 900 which is then used to support and position structural mesh when securing said mesh to shaft walls in an effort to enhance their support. Other tools may be supported by the collar 190 or in the socket for the chisel 180.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A scaling bar comprising:
an tubular outer handle;
a cylindrical neck, coaxial with the outer handle and having a sliding relationship therein;
a latching mechanism for securing the cylindrical neck inside the outer handle at a set length relationship with each other; and
a chisel mounted within a forward end of the cylindrical neck.

2. The scaling bar of claim 1, the cylindrical neck also being tubular.

3. The scaling bar of claim 1, the cylindrical neck further comprising a collar circumscribing the cylindrical neck proximate the chisel.

4. The scaling bar of claim 1, the chisel being removable.

5. The scaling bar of claim 1, the cylindrical neck and the outer each having a at least one corresponding adjustment hole with which the latching mechanism interfaces.
